(19) United States
(12) Patent Application Publication
(10) Pub. No.: US 2021/0196012 A1
(43) Pub. Date: Jul. 1, 2021

(54) COMPONENT BASED SYSTEM FOR ASSEMBLING FLEXIBLE GEOMETRIC STRUCTURES

(71) Applicant: Ezra Joseph Satok-Wolman, ONTARIO (CA)

(72) Inventor: Ezra Joseph Satok-Wolman, ONTARIO (CA)

(21) Appl. No.: 17/165,233

(22) Filed: Feb. 2, 2021

Related U.S. Application Data
(63) Continuation-in-part of application No. 15/696,915, filed on Sep. 6, 2017, now Pat. No. 10,905,967.
(60) Provisional application No. 62/384,289, filed on Sep. 7, 2016.

(51) Int. Cl. A44C 13/00; B44C 3/12

(52) U.S. Cl. CPC A44C 13/00; B44C 3/12

(57) ABSTRACT

An assembly structured to form a customizable, variably configured geometric structure, which includes a plurality of hubs each having an interior chamber and a plurality of housings. Each housing includes an open-ended interior channel communicating with the interior chamber of a common hub. A each of a plurality of elastic links are retained within and extend outwardly from a different one of said interior channels. At least one elastic link may be disposed in interconnecting relation between two attached ones of the plurality of hubs and a predetermined number of a plurality of attached hubs may be interconnected to one another to define a closed, continuously configured array of hubs. A plurality of the closed, continuously configured array of hubs may be disposed in interconnected relation to one another to define one of a possible plurality of the customizable, variably configured geometric structures.

### CLAIM OF PRIORITY

This application is a Continuation in Part of U.S. patent having Ser. No. 15/696,915, which was filed on Sep. 6, 2017, which is set to mature to U.S. Pat. No. 10,905,967 on Feb. 2, 2021 which in turn is based on and a claim of priority is made under 35 U.S.C. Section 119(e) to a provisional patent application that is currently pending in the U.S. Patent and Trademark Office, namely, that having Ser. No. 62/384,289 and a filing date of Sep. 7, 2016, all applications which is incorporated herein by reference.

### BACKGROUND OF THE INVENTION

### Field of the Invention

The present invention is directed to an assembly structured to form any one of a possible plurality of customizable, variably configured, flexible, geometric structures through the interconnection of a plurality of component hubs to one another into a closed, continuously configured array of hubs. A plurality of the closed, continuously configured array of hubs may be interconnected to define a selected one of the possible plurality of the customizable variably configured geometric structures.

### Description of the Related Art

Different fields of art include products, devices, materials, etc. which are intended to be variably structured to form a variety of differently configured and dimensioned objects. Such different fields of art include, but are not limited to, jewelry, sculpture, fashion, industrial design, architecture, structural engineering, nano-engineering, aerospace and the medical field.

By way of example only jewelry pieces have a tendency to be rigid and thereby are not well adapted to conform to various body portions of the wearer, wherein such jewelry pieces may include bracelets, necklaces, etc. Such rigidity or lack of adaptability may result in discomfort to the wearer as well as an increase in the possibility of damage to or breakage of the jewelry pieces.

In order to overcome problems and disadvantages of the type set forth above, not only in the jewelry art but in other fields of endeavor as well there is a need for a component-based assembly and/or system for the making of different flexible geometric structures, wherein such preferred and proposed geometric structures may be formed into any one of a possible plurality of customizable, variably configured structures. As such, a proposed and preferred assembly and/or system of this type would facilitate the production and/or formation of different products, devices, goods, etc. in different fields of art which could assume a predetermined or preferred configuration while being sufficiently flexible and/or resilient to conform or adapt, in shape or size, to any other object, device, structure, etc., with which it is intended to be used.

Moreover, a preferred and proposed assembly and/or system could incorporate the use of a plurality of hub components each cooperatively structured with the other to be interconnected to one another, individually or in interconnected arrays, by means of elastic flexible links. The use of such interconnecting, elastic and flexible links, in combination with the cooperatively structured plurality of hubs, would significantly enhance versatility of a resulting geometric structure by allowing a variance in the size, shape, flexibility, elasticity, adaptability, etc., of the end product.

### SUMMARY OF THE INVENTION

The present invention is directed to an assembly and/or system structured to form any one of a possible plurality of customizable, variably configured geometric structures capable of defining a variety of different objects, devices and/or goods such as, but not limited to, jewelry pieces or other different fields of art. The customizable, variably configured geometric structure comprises a plurality of interconnected hub components cooperatively structured with and interconnected by a plurality of elastic links.

More specifically, at least one but more practically a plurality of the hub components or “hubs” each include an interior chamber and a plurality of housings. The housings may vary in number and extend radially outward from a base or body of a common hub, which may be at least partially defined by interconnected inner ends of associated ones of the plurality of housings. Accordingly, the hubs are at least partially defined by the corresponding plurality of housings each having their inner or proximal ends fixedly connected to one another in adjacent and/or contiguous relation.

Further, each of the housings include an interior channel which includes oppositely disposed open ends. An open inner end of each of the plurality of interior channels of the housings of a common hub are disposed in direct communicating relation with the interior chamber thereof. As described in greater detail hereinafter, a connector structure may be disposed on each of the plurality of hubs, at least partially within the interior chamber.

In addition, a plurality of elastic links are associated with each of the plurality of hubs and for a given hub, are equal in number to the number of housings associated with that hub. Further, each of the plurality of elastic links includes opposite ends and are disposed and retained within a different one of the interior channels of the housings associated with a given hub. Also, each of the elastic links may be dimensioned and configured to have one of the opposite ends disposed at least partially within the interior chamber of an associated hub. As such, each of the elastic links extend along the length of a corresponding interior channel and outwardly from an outer open end thereof. Accordingly, each of the opposite ends of each elastic link may include an attachment member cooperatively dimensioned, configured and structured with the aforementioned connector structure. The correspondingly positioned one of the attachment members is disposed within the interior chamber of the corresponding hub. The cooperative structuring between the attachment members of each of the elastic links and that of the connector structure facilitates a retaining connection of each of the elastic links into respective ones of the interior channels.

Additional structural and operative features of one or more preferred embodiments of the assembly of the present invention may also include a removable disposition of the connector structure within the interior chamber. Therefore, each of the corresponding elastic links connected to the removable connector structure may be defined as being “removably retained” within individual ones of the interior channels. This removable retention further facilitates the structure and cooperative use of the plurality of hubs as well as their interconnection to one another, as set forth in greater detail hereinafter. Also, the provision of attachment members on or integrated with each of the opposite ends of each of the plurality of elastic links allows either end of the elastic links to be disposed in a retained relation within any of the interior channels of any of the plurality of housings of any of the plurality of cooperatively structured hubs.

The plurality of elastic links may be structured in the form of generally elongated spring members such as, but not limited to, a coil spring. Regardless of their specific form, the elastic links/spring members are structured to be both elastic and flexible and include an inherent bias. Such inherent bias facilitates the tendency of the elastic link/spring member to return from an elastically expanded or flexibly deformed orientation, when force or tension is applied thereto, back into an original or initial orientation, when the applied force or tension is reduced or removed. Such inherent bias will further facilitate an enhanced versatility of the assembly and the adaptability of the resulting or formed geometric structure to conform to different shapes, sizes, etc. of a device, object, etc. with which the geometric structure is used.

As will also be explained in greater detail hereinafter, a predetermined number of the plurality of hubs may be disposed in interconnected relation to one another to define a closed, continuously configured array of hubs. The size and configuration of each of such array of hubs may vary dependent on the number of hubs being interconnected to form and/or define a given interconnected array of hubs. In addition, a plurality of the closed, continuously configured array of hubs may be disposed in interconnected relation to one another to define one of a possible plurality of the customizable, variably configured geometric structures.

It will be further noted that the versatile structural and operational features of each of the plurality of hubs and each of the plurality of elastic links significantly facilitate the interconnection of the plurality of hubs to one another to form the closed, continuously configured array of hubs. Similarly, the plurality of elastic links are used to define the interconnection of the plurality of hub arrays to one another, to form any one of a possible plurality of customizable, variably configured geometric structures.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective detailed view of one preferred embodiment of a hub component of the assembly of the present invention.

FIG. 2 is a perspective view in partial cutaway of the embodiment of FIG. 1.

FIG. 3 is a perspective view in exploded form of the embodiment of the hub component as represented in FIGS. 1 and 2.

FIG. 4 is a perspective view of a plurality of hub components connected to one another to define one or more closed, continuous arrays of hubs.

FIG. 5 is a perspective view of a flexible, multi-hub component geometric structure comprised of a plurality of closed, continuously configured array of hubs, disposed in interconnected relation to one another.

FIG. 6A is a schematic depiction of a plurality of closed, continuous arrays of hubs disposed in a hexagonal arrangement, according to one embodiment of the present invention.

FIG. 6B is a schematic depiction of a plurality of closed, continuous arrays of hubs disposed in a hexagonal and pentagonal arrangement, according to another embodiment of the present invention.

FIG. 6C is a schematic depiction of a plurality of closed, continuous arrays of hubs disposed in a hexagonal, pentagonal, and heptagonal arrangement, according to another embodiment of the present invention.

FIG. 7 is a section view of a plurality of hub components in accordance with one embodiment of the present invention.

Like reference numerals refer to like parts throughout the several views of the drawings.

### DETAILED DESCRIPTION OF THE PREFERRED EMBODIMENT

As represented in the accompanying Figures, the present invention is directed to an assembly and/or system structured to form any one of a possible plurality of customizable, variably configured geometric structures 200 capable of defining a variety of different objects, devices and/or goods such as, but not limited to, jewelry pieces or other different fields of art. The customizable, variably configured geometric structure 200 comprises a plurality of interconnected hub components 10 cooperatively structured with and interconnected by a plurality of elastic links 16.

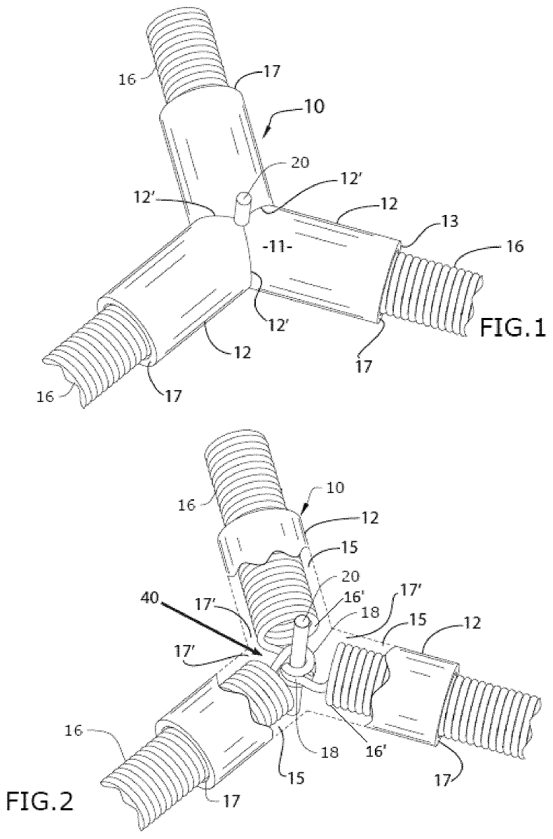

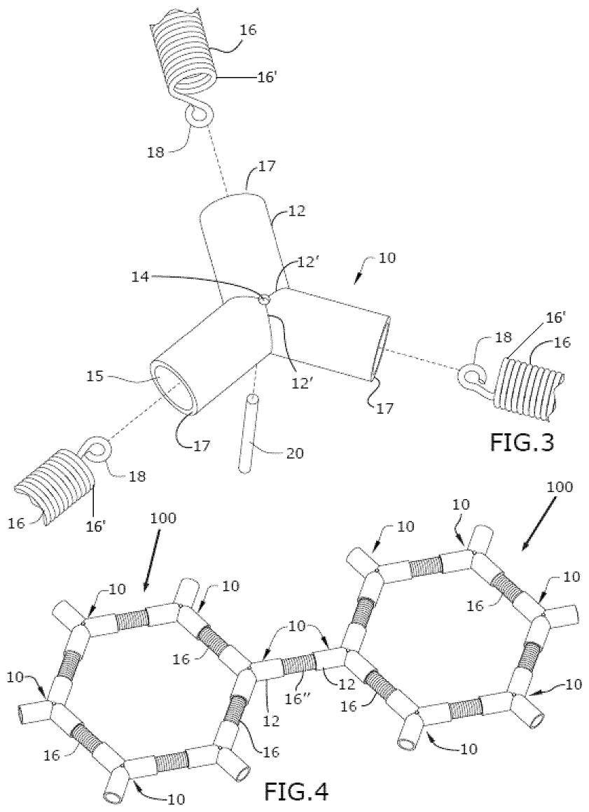

More specifically, at least one but more practically a plurality or majority of the hub components or “hubs” 10 each include an interior chamber 40 and a plurality of housings 12. The housings 12 may vary in number and extend radially outward from interconnected inner or proximal ends 12, at least partially defining a base or body 11, of a common hub 10 in spaced relation to one another, as clearly represented in at least FIGS. 1 and 3. In addition, the represented hub 10 is at least partially defined by the corresponding plurality of housings 12 each having oppositely disposed open distal and proximal ends 17 and 17′ respectively. As also represented in the accompanying Figures, the open inner or proximal ends 17′ communicate directly with the interior chamber 40, which in turn is at least partially defined by the interconnected inner or proximal ends 12′ of the corresponding plurality of housings 12.

Further, each of the housings 12 include an open interior channel 15 communicating with the oppositely disposed open ends 17 and 17′. As indicated, an open inner end 17′ of each of the plurality of interior channels 15 of the housings 12 of a common hub 10 is disposed in direct communicating relation with the interior chamber 40 thereof. As described in greater detail hereinafter, a connector structure 20 may be disposed on each of the plurality of hubs 10, at least partially within the interior chamber 40. More specifically, the connector structure 20 may be removably inserted into the interior chamber 40 by passing through an access opening or aperture 14. In addition, a plurality of elastic links 16 are associated with each of the plurality of hubs 10. Further, the plurality of elastic links 16 for a given hub 10 are equal in number to the number of housings 12 and are operatively and at least partially movable within the interior channels 15 of that hub 10. Further, each of the plurality of elastic links 16 includes opposite ends 16′, as represented in at least FIGS. 3 and 7. As set forth herein, each elastic link 16 is disposed and retained within a different one of the interior channels 15 of the housings 12, wherein one opposite end 16′ is at least partially disposed within and/or communicates with the interior chamber 40 of an associated hub 10 via the open end 17′ of the corresponding housing 12. In addition, each of the opposite ends 16′ of each elastic link 16 may include an attachment member 18 cooperatively dimensioned, configured and structured with the aforementioned connector structure 20 to facilitate connection therebetween. Moreover, each of the attachment members 18 are preferably integrated in and thereby at least partially define a corresponding end 16′ of the respective elastic links 16. As such, correspondingly positioned inner ones of the attachment members 18 are also disposed within the interior chamber 40 of the corresponding hub 10, so as to facilitate attachment to the connector structure 20. The cooperative structuring between the attachment members 18 of each elastic links 16 and that of the connector structure 20 facilitates a retaining connection of each elastic links 16 into associated ones of the interior chambers 40. Further, to facilitate interconnection of the attachment members 18 with the connector structure 20, the attachment members 18 may be structured to include or at least partially define a hook or loop-like configuration. Such hook or loop-like configuration is cooperatively dimensioned and configured with the connector structure 20 so as to at least partially surround the connector structure 20 as represented throughout the Figures. Such a configuration is depicted throughout the Figures, and specifically in FIG. 7, showing a section view of two hubs 10 adjoined with a common elastic link 16″, via connector structures 20, each disposed through attachment members 18 disposed on opposite ends of the common elastic link 16″.

Additional structural and operative features of one or more preferred embodiments of the assembly of the present invention may also include a removable disposition of the connector structure 20 within the interior chamber 40, such as by being removably disposed within the access opening or aperture 14. Therefore, each of the corresponding elastic links 16 connected to the removable connector structure 20 may be “removably retained” within individual ones of the interior channels 15. This removable retention further facilitates the structure and cooperative use of the plurality of hubs 10 as well as their interconnection to one another, as set forth in greater detail hereinafter. Also, the provision of attachment members 18 on or integrated with each of the opposite ends 16′ of each of the plurality of elastic links 16 allows either end 16′ and corresponding ones of the attachment members 18 of the elastic links 16 to be disposed in a retained relation within any of the interior channels 15 of any of the plurality of housings 12 of any of the plurality of cooperatively structured hubs 10.

The plurality of elastic links 16 may be utilized in the form of generally elongated spring members such as, but not limited to, coil springs. Regardless of their specific form, the elastic links/spring members 16 are structured to be both elastic and flexible and include an inherent bias. Such inherent bias facilitates the tendency of the elastic link/spring member 16 to return from an elastically expanded or flexibly deformed orientation, when force or tension is applied thereto, back into an original or initial orientation, when the applied force or tension is reduced or removed. Such an original or initial orientation is represented in at least FIGS. 1 and 2. Further, the inherent bias of the elastic links 16 will facilitate an enhanced versatility of the assembly and the adaptability of the resulting or formed geometric structure 200 to conform to different shapes, sizes, etc. of a device, object, etc. with which the geometric structure 200 is used.

As will also be explained in greater detail hereinafter, a predetermined number of the plurality of hubs 10 may be disposed in interconnected relation to one another to define a closed, continuously configured array 100 of hubs 10 as clearly represented in FIG. 4. The size and configuration of each array 100 of hubs 10 may vary dependent on the number of hubs 10 being interconnected to form and/or define a given interconnected array 100. More specifically, each of the hub arrays 100 represented in FIG. 4 include six interconnected hubs 10, thereby defining a hub array 100 having six sides. However, other closed continuous arrays of hubs 100 may include a different, predetermined number of hubs 10 being interconnected to one another in a closed, continuously configured array 100. By way of example only, if four hubs 10 were interconnected to one another in a closed, continuously configured array, the number of sides of such an array would be four in number. Similarly, and further by way of example, if three of the hubs 10 were interconnected to one another in a closed, continuously configured array, the number of sides of the closed, continuously configured array would be three in number. Accordingly, the predetermined number of hubs 10 in each of the closed, continuously configured arrays 100 is determinative of one of a possible plurality of configurations of said closed, continuously configured array 100.

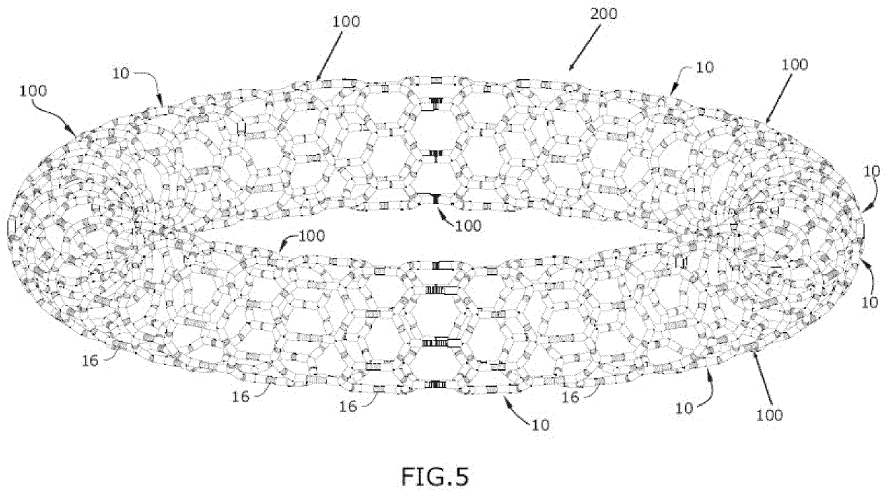

In addition and as represented in FIG. 5, a plurality of the closed, continuously configured arrays 100 of hubs 10 may be disposed in interconnected relation to one another to define one of a possible plurality of the customizable, variably configured geometric structures 200. As represented, the geometric structure 200 includes an overall annular, circular, torus, toroidal, etc. configuration made up of the plurality of interconnected arrays 100 of hubs 10. However, it is emphasized that the substantially annular configuration of the geometric structure 200 of FIG. 5 is representative only of a larger number of possible configurations of the geometric structure 200 which may or may not be “continuous” or “closed”. Further by way of example, the geometric structure 200 of FIG. 5 may be representative of a piece of jewelry such as a bracelet, necklace, etc. It is again emphasized that the assembly of the present invention may be used to form customizable, variably configured geometric structures 200 having various shapes, sizes, etc.

It will be further noted that the versatile structural and operational features of each of the plurality of hubs 10 and each of the plurality of elastic links 16 significantly facilitate the interconnection of the plurality of hubs 10 to one another to form the closed, continuously configured array 100 of hubs 10. Similarly, the plurality of elastic links 16 are used to define the interconnection of the plurality of hubs 10 of each hub array 100. Further, one or more of the elastic links, as at 16″ in FIGS. 4 and 7 are used to interconnect different ones of the hub arrays 100 to one another, to form any one of a possible plurality of customizable, variably configured geometric structures 200. Therefore and as represented throughout the Figures, at least one of the elastic links, as at 16′, connected to one of the hubs 10 of a given hub array 100 may also be connected to one other of the plurality of hubs 10 which may be independent of but more practically associated with a different one of the hub arrays 100. Also, the configuration of each of the hub arrays 100 may be the same or may differ from one another in the formation of the customizable, variably configured geometric structure 200.

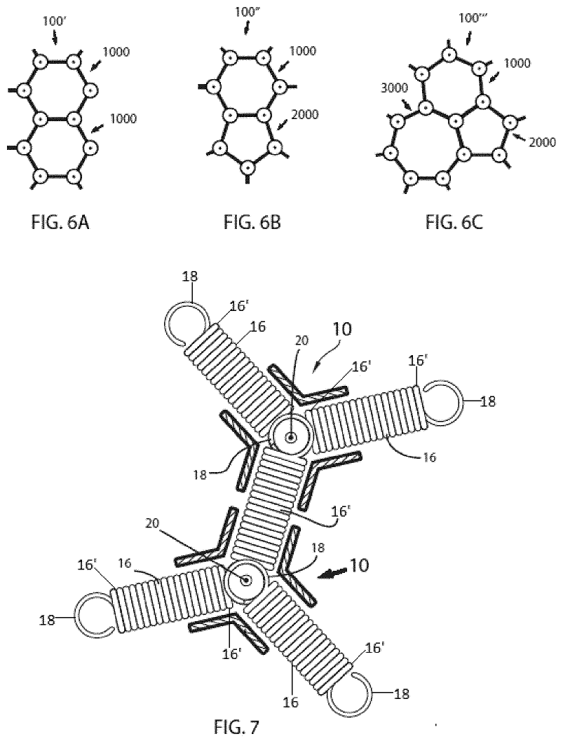

Now turning to FIGS. 6A, 6B, and 6C, schematic depictions of hub arrays 100′, 100″, and 100′″ according to various embodiments of the present invention can be seen. Specifically, FIG. 6A depicts an embodiment wherein the hub array 100′ includes at least two hexagonal arrangements 1000; FIG. 6B depicts an embodiment wherein the hub array 100″ includes at least one hexagonal arrangement 1000 and one pentagonal arrangement 2000; FIG. 6C depicts an embodiment wherein the hub array 100′″ includes at least one hexagonal arrangement, one pentagonal arrangement, and one heptagonal arrangement. Further variations and combinations may be achieved, as desired, due to the flexibility of the elastic links 16 which are capable of accommodating a wide variety of internal and external connection angles, regardless of the precise shape or configuration of the hub 10. In this regard, the elastic links 16 are adaptable to a user's desire or necessity and provides for the assembly of complex geometric structures, such as a buckminsterfullerene, which requires both hexagons and pentagons that share hubs 10 or hub arrangements 1000. With regard to the depicted embodiments throughout the Figures, the hubs 10 include a 120 degree connection angle, though virtually any angle may be utilized, but if a different connection angle is desired, such as 108 degrees, used in forming a pentagon, the elastic links 16 accommodate such an angle.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. An assembly structured to assume a customizable variably configured geometric structure, said assembly comprising:
a plurality of elastically and flexibly interconnected hubs disposed in an initial orientation,
a majority of said plurality of hubs including a central chamber and a plurality of housings fixedly interconnected to one another at correspondingly disposed proximal ends thereof,
each of said plurality of housings including a different one of a plurality of interior channels;
each of said plurality of interior channels having open inner end and an open outer end,
said open inner ends of each of said plurality of interior channels disposed in communicating relation with and at least partially encompassing said interior chamber of a common one of said majority of hubs,
a plurality of elastic links each retained within a different one of said plurality of interior channels and at least partially disposed within said interior chamber of a common one of said majority of hubs; and
at least one of said elastic links of one of said majority of hubs retained within said interior channel of another interconnected one of said majority of hubs.

2. The assembly as recited in claim 1 wherein each of said plurality of elastic links further includes an inherent bias operative to return said plurality of hubs from an elastically expanded and flexibly deformed orientation to said initial orientation.

3. The assembly as recited in claim 1 wherein each of said elastic links of a common one of said majority of hubs includes one end retained within said interior chamber of said common hub.

4. The assembly as recited in claim 3 further comprising a connector structure disposed within said interior channel of each of said majority of hubs thereof, each of said elastic links of a common one of said majority of hubs attached in retaining relation to a corresponding one of said connector structures.

5. The assembly as recited in claim 4 wherein said connector structure is removably disposed within said interior chamber in removable, retaining engagement with said elastic links of a common one of said majority of hubs.

6. The assembly as recited in claim 1 wherein said plurality of housings of a common one of said majority of hubs extend radially outward from a central portion of said common hub in spaced relation to one another.

7. The assembly as recited in claim 6 wherein said plurality of housings of said common one of said majority of hubs are disposed in substantially equally spaced relation to one another.

8. The assembly as recited in claim 6 wherein said plurality of housings on said common one of said majority of hubs extend radially outward from said interior channel said common hub in equally angular spaced relation to one another.

9. The assembly as recited in claim 1 wherein each of said elastic links includes a flexible spring member variably deformable and inherently biased into said initial orientation.

10. The assembly as recited in claim 1 further comprising a predetermined number of said majority of hubs disposed in interconnected relation to one another in a closed, continuous array.

11. The assembly as recited in claim 10 wherein said predetermined number of hubs in each of said majority of hubs is determinative of each of a plurality of configurations of said closed, continuous array of hubs.

12. The assembly as recited in claim 10 further comprising a flexible, multi-hub component geometric structure comprising a plurality of said closed, continuous arrays of hubs disposed in interconnected relation to one another.

13. An assembly structured to assume a customizable variably configured geometric structure, said assembly comprising: An assembly disposed to maintain a plurality of interconnected hub arrays by forming an elastically expanded orientation or a flexibly deformed orientation upon the application of force thereto, said assembly comprising:
a plurality of hub arrays interconnected in an initial orientation, each of said plurality of hub arrays disposed to form one of a plurality of geometric configurations independent of a configuration of adjacent ones of said plurality of hub arrays;
each of said plurality of hub arrays comprising a closed, continuous configuration defined by a plurality of elastically and flexibly interconnected hubs;
each of said plurality of hubs including a plurality of housings, each of said plurality of housings including a different one of a plurality of interior channels; each of said interior channels having an open inner end and an open outer end;
each of said plurality of hubs further including an interior chamber disposed in communicating relation with each of said open inner ends of corresponding ones of said plurality of interior channels;
a plurality of elastic links each retained within a different one of said interior channels and including one end extending outwardly into said interior chamber,
a connector disposed within said interior chamber in interconnecting, retaining attachment to said one ends of said plurality of elastic links, and
each of said plurality of hubs interconnected through one of said plurality of elastic links disposed in said interior channel of another interconnected one of said plurality of hubs.
each of said elastic links removably retained within said hub via a single connector structure disposed through said at least one aperture and through each of said loop configurations within said hub.

14. The assembly as recited in claim 13, wherein said geometric configuration includes a different connection angle between interconnected hubs than that formed by said at least three housings of each of said plurality of interconnected hubs.

15. The assembly as recited in claim 13, wherein each of said loop configurations disposed within each of said plurality of interconnected hubs is disposed in an overlying configuration for the insertion of said single connector structure therethrough.

16. The assembly as recited in claim 13 each of said plurality of hubs further including at least one aperture disposed therethrough in communicating relation with said interior chamber.

17. The assembly as recited in claim 16 wherein said connector is disposed through said at least one aperture into said interior chamber in said interconnecting, retaining attachment to said one ends of said plurality of elastic links.

18. The assembly as recited in claim 17 wherein each of said plurality of elastic links includes a loop configuration disposed on each opposite end thereof, said loop configuration on said one end of said plurality of elastic links disposed in engaging relation to said connector.

19. The assembly as recited in claim 13 wherein each of said plurality of elastic links further includes an inherent bias operative to return said plurality of hubs from an elastically expanded and flexibly deformed orientation to said initial orientation.

20. The assembly as recited in claim 13 The assembly as recited in claim 1 wherein said plurality of housings of a common one of said majority of hubs extend radially outward from a central portion of said common hub in spaced relation to one another.
